(19) United States
(12) Patent Application Publication
(10) Pub. No.: US 2017/0369371 A1
(43) Pub. Date: Dec. 28, 2017

(54) DERIVATIZED POLYIMIDES AND METHODS OF MAKING AND USING

(71) Applicants: Dow Global Technologies LLC, Midland, MI (US); Rohm and Haas Company, Philadelphia, PA (US)

(72) Inventors: William J. Harris, Lake Jackson, TX (US); Thomas Oswald, Galveston, TX (US); Charles J. Rand, Philadelphia, PA (US); Jeffrey D. Weinhold, Lake Jackson, TX (US)

(21) Appl. No.: 15/535,951

(22) PCT Filed: Dec. 22, 2014
(86) PCT No.: PCT/US2015/064715

§ 371 Date: Jun. 14, 2017

Related U.S. Application Data
(60) Provisional application No. 62/095,248, filed on Dec. 22, 2014.

(51) Int. Cl. C04B 24/24; C04B 24/26; C08F 2/38; C08G 81/02; C09D 143/02; C04B 103/00; C04B 103/44; C08L 33/24

(52) U.S. Cl. CPC C04B 24/243; C08F 2/38; C04B 24/2658; C04B 24/2647; C08G 81/025; C04B 2103/006; C04B 2103/44; C08L 33/24; C08L 2201/54; C09D 143/02

(57) ABSTRACT

The present invention provides comb polymer compositions comprising phosphorus acid group containing backbone polymers of six-membered cyclic methacrylic imide having one or more side chain ether group containing N-substituent chosen from an ether group, a polyether group, an etheramine group, a polyetheramine group, an ether group crosslinking the backbone polymer chains, and a polyether group crosslinking the backbone polymer chains. The backbone polymers comprise from 60 to 100 wt. %, based on the total weight of monomers used to make the backbone polymer, of methacrylic acid polymerized units, regardless of their form, and from 7.5 to 95 wt. % of such polymerized units as methacrylic anhydride groups or six-membered cyclic methacrylic imide groups.

The present invention relates to phosphorus acid group containing comb polymers of methacrylic imide. More particularly, it relates to phosphate, phosphite and hypophosphite group containing comb polymers of six-membered cyclic methacrylic imide having ether group containing, e.g., polyether, side chains and to methods for making them and using them, for example, as thickeners.

Materials currently used to increase viscosity in aqueous compositions include various natural gums, such as guar gum and xanthan gum, as well as cellulose ethers and blends thereof. Cellulose ethers, for example, are well known as viscosity modifying agent additives or thickeners for concrete and mortar production; cellulose ethers are formed from plant sources, e.g., pulp, by a very expensive multistep process; and, at present, the cost of a single manufacturing line used for making cellulose ethers ranges well into the hundreds of million dollars. As the thickening provided by a cellulose ether relies on its nature as a stiff polymer chain, there remains a need for making a polymer having a stiff chain by a simple process that is less capital intensive than the process for making cellulose ethers.

In addition, cellulose ether and gum materials are susceptible to microbial attack, especially at the temperatures present in oil and gas formations. As a result, various biocides are required to protect the thickener, thereby preventing the formation of undesirable polysaccharide by-products by the microbes that can reduce the permeability in oil and gas formations being treated and therefore reduce hydrocarbon production rate. There remains a need to make a thickener for water or aqueous mixtures that is not susceptible to microbial attack. U.S. Pat. No. 4,742,123 to Kopchik discloses the preparation of generic polyacrylic anhydrides and their corresponding imides from aqueous polymers of acrylic acid, methacrylic acid or their copolymers with a large number of comonomers by extrusion at from 200 to 300° C. Such polymers are somewhat thermally stable at the weight average molecular weights (Mw) of 150,000 mentioned in Kopchik; however, Kopchik only forms high molecular weight polymers because the lower Mw versions of these polymers, for example, at 20,000 or below, such polymers will not form under the extrusion conditions disclosed in Kopchik; they hydrolyze or decompose under the Kopchik extrusion conditions.

The present inventors have sought to solve the problem of providing a thermally stable polymeric thickener material for use in aqueous compositions and simplified, low VOC or VOC free methods for making them.

### STATEMENT OF THE INVENTION

1. In accordance with the present invention, comb polymer compositions comprise phosphorus acid group containing, preferably, hypophosphite group containing, backbone polymers of six-membered cyclic methacrylic imide having one or more, or, preferably, 2 or more, or, more preferably, 5 or more side chain ether group containing N-substituents on a six-membered cyclic methacrylic imide chosen from an ether group, a polyether group, an etheramine group, a polyetheramine group, an ether group crosslinking the backbone polymer chains, and a polyether group crosslinking the backbone polymer chains, and at least one methacrylic acid in polymerized form, its quaternary ammonium carboxylate group, preferably, dimethyl di(dodecyl) ammonium ([CH₃)₂(C₁₂H₂₅)₂N]⁺), its metal carboxylate group salt, or an ester side chain group or amide side chain group chosen from a hydrophobic side chain, for example, a polyolefin ester or amide or a C₁ to C₅₀₀, preferably, a C₆ to C₂₅₀, or, more preferably, a C₆ to C₁₅₀ alkyl or fatty alkyl ester or amide, a polyether ester side chain, a polyether amide side chain, a, and combinations thereof, wherein the backbone polymers comprise from 60 to 100 wt. %, or, preferably, from 75 to 100 wt. %, or, more preferably, 90 to 100 wt. %, or, most preferably, 95 to 100 wt. %, based on the total weight of monomers used to make the backbone polymer, of methacrylic acid polymerized units, regardless of their form.

2. In accordance with the comb polymer compositions of item 1, above, further wherein, the backbone polymer comprises from 7.5 to 95 wt. %, or less than 70 wt. %, or, preferably, from 50 to 68 wt. %, or, more preferably, from 60 to 66.7 wt. %, of the methacrylic acid polymerized units in the form of methacrylic anhydride groups or six-membered cyclic methacrylic imide groups which are formed from the methacrylic anhydride groups, as determined by titration of the backbone polymers containing methacrylic anhydride groups prior to forming the six-membered cyclic methacrylic imide groups to determine the total number methacrylic anhydride groups therein.

3. In accordance with the comb polymer compositions of items 1 or 2, above, the phosphorus acid group containing backbone polymers of six-membered cyclic methacrylic imide of the present invention, excluding the weight of any side chain groups or salt groups in the backbone polymers, have a weight average molecular weight (Mw) of from 1,000 to 25,000 or, preferably, 2,000 or more, or, preferably, 15,000 or less, or, more preferably, 10,000 or less.

4. In accordance with the comb polymer compositions of items 1, 2 or 3, above, wherein the phosphorus acid group containing backbone polymers of six-membered cyclic methacrylic imide further contain one or more methacrylic anhydride group or six-membered cyclic methacrylic anhydride group.

5. In accordance with the comb polymer compositions of any one of items 1, 2, 3, or 4, above, the phosphorus acid group containing backbone polymers of six-membered cyclic methacrylic imide of the present invention have one or more hypophosphite group and comprise from 1 to 20 wt. %, or 2 wt. % or more, or, preferably, 4 wt. % or more, or, preferably, 15 wt. % or less of the hypophosphite compound or its salts such as, for example, sodium hypophosphite, in polymerized form, based on the total weight of reactants (i.e., monomers, hypophosphite compounds and chain transfer agents) used to make the backbone polymer.

6. In accordance with the comb polymer compositions of any one of items 1, 2, 3, 4, or 5, above, the phosphorus acid group containing backbone polymers comprise the reaction product of less than 2 wt. %, based on the total weight of reactants used to make the backbone polymer, of reactants other than a phosphorus acid compound and methacrylic acid, or its salt.

7. In accordance with the comb polymer compositions of any of items 1, 2, 3, 4, 5, or 6, above, wherein the backbone polymer is a substantially linear polymer having 3 wt. % or less of total methacrylic anhydride groups formed by backbiting or intrachain polymer crosslinking, based on the total weight of methacrylic acid polymerized units.

8. In accordance with the comb polymer compositions of any of items 1, 2, 3, 4, or 5, 6, or 7, above, wherein the ether group containing N-substituent is chosen from an ethoxy group, a propoxy group, a diethylene glycol, a dipropylene glycol, a polyether of ethylene oxide repeat units, preferably, a polyether of at least 90 wt. % of ethylene oxide repeat units, a polyether of propylene oxide repeat units, a polyether having ethylene oxide and propylene oxide units, and mixtures and combinations thereof.

9. In accordance with the comb polymer compositions of item 8, above, wherein the ether group containing N-substituent comprises a polyethers having at least 60 wt. %, or, preferably, at least 80 wt. % or, more preferably, at least 90 wt. % of ethylene oxide repeat units, based on the total weight of the ether group containing N-substituent.

10. In accordance with the comb polymer compositions of any of 1, 2, 3, 4, 5, 6 7, or 8, above, wherein the comb polymers are crosslinked and comprise at least one bis-imide ether crosslink connecting six-membered cyclic methacrylic imide groups which is an ether bis-imide, a diether bis-imide or a polyether bis-imide chain.

11. In accordance with the comb polymer compositions of any of 1 to 10, above, wherein the comb polymer has an Mw of from 1200 to 1,500,000, or, preferably, from 5000 to 250,000, the Mw being that of the backbone polymer in fully hydrolyzed form prior to the formation of any six-membered cyclic methacrylic imide groups thereon by GPC against a polyacrylic acid standard plus the total amount of any N-substituent groups, salts, quaternary ammonium groups, ester side chain groups, or amide side chain groups reacted with or contained in the backbone polymer as determined by N-substituent group yield, ester side chain yield, and amide side chain yield from any alcohol or amine compound as determined via NMR.

12. In accordance with the compositions of any of items 1 to 11, above, wherein the phosphorus acid group containing backbone polymers of six-membered cyclic methacrylic imide comprise powders, pellets, granules, suspensions thereof in non-aqueous carriers, such as oils, e.g., vegetable oils, glycols, polyglycols, ethers, glycol ethers, glycol esters and alcohols or solutions in solvents chosen from, dimethyl sulfoxide (DMSO), dimethyl formamide (DMF), and N-methyl pyrrolidinone (NMP).

13. In another aspect of the present invention, methods for making comb polymers which are phosphorus acid group containing backbone polymers of six-membered cyclic methacrylic imide having one or more side chain ether group containing N-substituents chosen from an ether group, a polyether group, an etheramine group, a polyetheramine group, an ether group crosslinking the backbone polymer chains, and a polyether group crosslinking the backbone polymer chains comprise aqueous solution polymerizing a monomer mixture of methacrylic acid and/or its salt with one or more phosphorus acid compound, preferably, hypophosphite and/or its salt to form a precursor polymer having methacrylic acid polymerized units, drying the precursor polymer, preferably without agitation, in a melt at from 175 to 250° C., to form a methacrylic anhydride group containing backbone polymer having from 7.5 to 95 wt. %, or less than 70 wt. % or, preferably, from 50 to 68 wt. %, or, more preferably, from 60 to 66.7 wt. %, of the methacrylic acid polymerized units in the form of methacrylic anhydride, as determined by titration of the backbone polymer, and then reacting in a fluid medium, such as in a melt or non-aqueous dispersion or solution, at from 0 to 220° C., such as from 15 to 140° C. the methacrylic anhydride group containing backbone polymer with one or more ether group containing amine compound, such as an ether amine, diether amine, polyether amine, bis-amine ether, tri-amine ether, tri-amine polyether, multiple amine ether, multiple-amine polyether, bis-amine diether or a bis-amine polyether in a molar amount of amine, preferably, not to exceed the moles of methacrylic anhydride in the methacrylic anhydride group containing backbone polymer, as determined by titration, to form at least one ether group containing amic acid group, and then reacting in a fluid medium the ether group containing amic acid group with a neighboring methacrylic acid group on the backbone polymer at from 100 to 250° C. or, preferably, 160 to 220° C. to form ether group containing N-substituents and six-membered cyclic methacrylic imide groups on the backbone polymer.

14. In accordance with the methods of item 13, above, wherein the drying of the precursor backbone polymer comprises heating it to a temperature of 180° C. or more or, preferably, 220° C. or less, or, more preferably, 200° C. or more, to form a methacrylic anhydride group containing backbone polymer.

15. In accordance with the methods of items 13 or 14, above, wherein the drying takes place in an oven, an extruder, kneader or kneader reactor, fluid bed dryer, evaporator, heated mixer and any of the foregoing following spray drying, preferably, an extruder, kneader or kneader reactor comprising a low shear zone. The drying time ranges from 10 seconds to 480 minutes, or, preferably, from 30 seconds to 120 minutes.

16. In accordance with the methods of any of items 13, 14 or 15, above, wherein the drying and reacting in a fluid medium takes place in the same extruder, kneader or kneader reactor such that any ether group containing amine compound is added downstream from where drying of the precursor polymer has taken place.

17. In accordance with the methods of any of items 13, 14, 15, or 16, above, wherein the reacting in a fluid medium takes place in a reaction vessel in a non aqueous aprotic solvent such as, for example, N,N-dimethylformamide, N,N-dimethylacetamide, N-methyl-2-pyrrolidone, or, preferably, N,N-dimethylacetamide, N-methyl-2-pyrrolidone.

18. In yet another aspect of the present invention, aqueous compositions comprise one or more comb polymers which are phosphorus acid group containing backbone polymers of six-membered cyclic methacrylic imide having one or more ether group containing N-substituent on the imide and at least one methacrylic acid, methacrylic acid salt, ester group containing side chain, or amide group containing side chain, such as, a C₁ to C₅₀₀, or, preferably, a C₆ to C₂₅₀, or, more preferably, a C₆ to C₁₅₀ alkyl or fatty ester or amide, metal salt or a quaternary ammonium carboxylate, and any of hydraulic cements, aqueous vinyl or acrylic emulsion polymers, oil or hydrocarbons from a subterranean formation as a non-aqueous phase, and a gaseous hydrocarbon.

19. In accordance with the compositions of item 18, above, wherein the compositions comprise from 0.1 to 30 wt. %, or, preferably, from 0.2 to 15 wt. %, or, more preferably, up to 8 wt. % of the one or more phosphorus acid group containing backbone polymers of cyclic methacrylic imide having one or more ether group containing N-substituents.

20. In accordance with the compositions of item 19, above, wherein the backbone polymers comprise from 60 to 100 wt. %, or, preferably, from 75 to 100 wt. %, or, more preferably, 90 to 100 wt. %, or, most preferably, 95 to 100 wt. %.

As used herein, the term “acid polymerized units” refers to the polymerized form of addition polymerizable carboxylic acids and salts thereof, such as acrylic or methacrylic acid; this includes, for example, for methacrylic acid polymerized units the total of methacrylic acid groups, in polymerized form, as their anhydride, e.g., methacrylic anhydride, their imide form, e.g., methacrylic imide, their acid or salts, e.g., methacrylic acid or its salts, or their esters or amides formed in making the polymer of the present invention, e.g., fatty, hydrophobic or quaternary ammonium functional methacrylates or methacrylamides. The term “acid polymerized units” excludes monomers that are not in their acid or salt form when polymers; thus, polymerized forms of (meth)acrylamides and alkyl methacrylate ester monomers, which are polymerized as ester and amide monomers, are not considered to be “methacrylic acid polymerized units”.

As used herein, the term “ASTM” refers to publications of ASTM International, West Conshohocken, Pa.

As used herein, the term “methacrylic acid polymerized units” refers to the polymerized form of methacrylic acid, its salts, its anhydride, methacrylic acid anhydride, i.e., polymerized methacrylic acid in anhydride form, its imide, i.e., polymerized methacrylic acid in imide form, and its ester or amide, i.e., polymerized methacrylic acid that is esterified or amidated after polymerization. Note that a single cyclic methacrylic anhydride or imide in polymerized form comprises two methacrylic acid polymerized units combined “head to tail” thereby forming 6 membered anhydride or imide rings.

As used herein, the term “monomers used to make the backbone polymer” excludes any reactants used to make quaternary ammonium carboxylate groups, metals in methacrylic acid salts, ester or amide side chains, such as amine or alcohol compounds, and ether group containing substituents on any methacrylic imide group.

As used herein, the term “based on the total weight of monomers” refers to the total weight of addition monomers, such as, for example, vinyl or acrylic monomers.

As used herein, the term “Fourier transform infrared (FTIR) spectroscopy” means, as indicated, that which creates a spectrum measured using a KBr pellet sample with material dispersed in a KBr carrier or a sample solution cast and vacuum dried on a polytetrafluoroethylene (PTFE) disposable infrared card with a ThermoNicolet™ Avatar 390 DTGS FTIR spectrometer (Thermo Fisher Scientific Waltham, Ma.) having data collection parameters set at 4 cm⁻¹ resolution, 32 scans, 32 background scans, under a nitrogen purge and an optical velocity of 0.6329.

As used herein, unless otherwise indicated, the term “molecular weight” or “Mw” refers to a weight average molecular weight of any methacrylic acid polymerized unit containing polymer as determined by aqueous gel permeation chromatography (GPC) using an Agilent 1100 HPLC system (Agilent Technologies, Santa Clara, Calif.) equipped with an isocratic pump, vacuum degasser, variable injection size auto-sampler, and column heater. The detector was a Refractive Index Agilent 1100 HPLC G1362A. The software used to chart weight average molecular weight was an Agilent ChemStation, version B.04.02 with Agilent GPC-add on version B.01.01. The column set was TOSOH Bioscience TSKgel G2500PW×I 7.8 mm ID×30 cm, 7 μm column (P/N 08020) (TOSOH Bioscience USA South San Francisco, Calif.) and a TOSOH Bioscience TSKgel GMPW×I 7.8 mm ID×30 cm, 13 μm (P/N 08025) column. A 20 mM Phosphate buffer in MilliQ HPLC Water, pH ˜7.0 was used as the mobile phase. The flow rate was 1.0 ml/minute. A typical injection volume was 20 μL. The system was calibrated using poly(acrylic acid), Na salts Mp 216 to Mp 1,100,000, with Mp 900 to Mp 1,100,000 standards from American Polymer Standards (Mentor, Ohio). Such an Mw is used to assess backbone polymer Mw.

As used herein, the term “Mw” of a fully hydrolyzed backbone polymer means that value determined by GPC, as above, for polymethacrylic acid polymers which result from hydrolysis of methacrylic anhydride group containing backbone polymers prior to formation of any six-membered cyclic methacrylic imide groups from the methacrylic anhydride groups on that polymer. It is assumed that all six-membered cyclic methacrylic imide groups on any backbone polymer are formed from methacrylic anhydride groups,

As used herein, the term “NMR” refers to either fluid or solid state nuclear magnetic resonance. NMR is used to determine reaction yield, whereby a comparison of the NMR signals corresponding to carbons in alcohols and esters (reacted, e.g., at a 4.2 ppm ester peak) or those in amine compounds, and either amides or imides (reacted) in the polymers tested were used for calculating the reacted portion of each alcohol or amine compound used to make the give polymer to assure higher precision in the quantitative analysis. Unless otherwise indicated, a ¹H NMR (Bruker 500 MHz NMR spectrophotometer, Bruker Corp., Billerica, Ma.) with water suppression was used for each indicated copolymer.

As used herein, the term “polyether” means any compound having three or more repeat ether groups.

As used herein, the term “titration” is as described below in the Examples for determining the methacrylic anhydride proportion and the carboxylic acid or salt proportion in a given comb polymer or backbone polymer. In any backbone polymer of methacrylic anhydride, the calculated percentage of COOH groups not converted into methacrylic anhydride, based on the total amount of methacrylic acid polymerized units, equals 100% minus the calculated percent of COOH groups that have been converted into anhydride groups. For any backbone polymer of the present invention having six-membered cyclic methacrylic imide groups, it is assumed that the six-membered cyclic methacrylic imide groups were formed from methacrylic anhydride groups; thus, the calculated percent of COOH groups not converted into anhydride or imide groups for any comb polymer is the same as the calculated percent of COOH groups not converted into anhydride in a corresponding backbone polymer which has methacrylic anhydride groups in place of any methacrylic imide groups.

As used herein, the term “phosphorus acid group in polymerized form” means the phosphorus acid group containing product of solution polymerization of monomers in the presence a phosphorus acid group containing compound.

As used herein, the term “water soluble” means that a given polymer composition readily disperses in water with stirring in at room temperature when neutralized with ammonia to a pH of 7.5, or that in use conditions ranging anywhere from 20 to 240° C. at least 1 g of the given polymer composition, as solids, dissolves in 100 g water at room temperature upon stirring for a period of less than 60 minutes or, preferably, for a period of from 1 second to 5 minutes.

As used herein, the term “wt. %” stands for weight percent.

All ranges recited are inclusive and combinable. For example, a disclosed temperature of 175 to 250° C., preferably, 180° C. or more or, preferably, 220° C. or less, or, more preferably, 200° C. or more, would include a temperature of from 175 to 180° C., from 175 to 220° C., from 175 to 200° C., from 180 to 250° C., preferably, from 180 to 220° C., preferably, from 180 to 200° C., preferably, from 200 to 250° C., more preferably, from 200 to 220° C., and from 175 to 250° C.

Unless otherwise indicated, all temperature and pressure units are room temperature and standard pressure.

All phrases comprising parentheses denote either or both of the included parenthetical matter and its absence. For example, the phrase “(poly)ether” includes, in the alternative, ether and polyether.

The present invention provides comb polymer compositions that can provide efficient viscosifiers for various applications in aqueous media and, as well, simple, cost effective methods for making the polymers. The phosphorus acid group containing six-membered cyclic methacrylic imide group containing comb polymers of the present invention have ether group containing N-substituents (on the methacrylic imide) side chains and/or, possibly, crosslinks linked to the nitrogen of the cyclic methacrylic imide, and are highly thermally stable for such low molecular weight polymers. Such comb polymers are made from phosphorus acid group containing methacrylic acid polymers that form methacrylic anhydrides at unusually low temperatures, approximately 30° C. lower than poly(methacrylic acid) (pMAA) polymers prepared in the absence of phosphorus acid compounds. In addition, the comb polymers of the present invention are formed from methacrylic anhydride containing backbone polymers that are thermally stable over a broad temperature range and do not readily char or decompose as do the corresponding backbone polymers of methacrylic acid prepared in the absence of phosphorus acids, like hypophosphite or its salts. Unlike their poly(acrylic acid) (pAA) or pAA anhydride analogues, the phosphorus acid group containing backbone polymers of methacrylic anhydride can be thermally formed without any decomposition. The presence of the imide structures in the polymer backbone increases the stiffness of the comb polymer and increases its ability to increase the viscosity of the water. The six-membered cyclic imide structure is also thermally stable at host polymer (such as polyethylene) processing temperatures.

Preferably, the comb polymers of the present invention or their methacrylic acid salts are water soluble and comprise side chain ether group containing N-substituents on at least 10 wt. %, or, preferably, from 15 to 100 wt. %, or, more preferably, at least 25wt. % of the six-membered cyclic methacrylic imide groups in the polymer chain, based on the total number methacrylic acid polymerized units in the cyclic imide form.

The structure of the six-membered cyclic methacrylic imide backbone polymers and comb polymers of the present invention permits simple modification of the polymer to create two or more differing functional groups. This reflects the structure of the cyclic methacrylic imide groups and any cyclic methacrylic anhydride groups on the backbone polymers which comprise from 7.5 to 95 wt. %, or less than 70 wt. % of the methacrylic acid polymerized units in the backbone polymer. The polymers of the present invention thus, preferably, do not contain significant amounts (≧3 wt. % of all such groups) of anhydrides that themselves crosslink or backbite onto backbone polymer chains. Thus, comb polymers of the present invention may comprise one or more alternating cyclic methacrylic anhydride or six-membered cyclic methacrylic imide groups and methacrylic acid or salt groups; such polymers may have, for example, the structure, [acid-(cyclic imide or anhydride-acid)]ₓ where x is from 1 to 120. Depending on the relative reactivity of each acid or residual anhydride, the resulting polymers can readily be modified on the acid or anhydride groups via amide or ester linkages without interfering with the imide groups.

Carboxylic anhydrides of methacrylic acid and their corresponding imides can form from the acidic functions of neighboring methacrylic acid polymerized units along a single polymer chain (cyclic), from acidic functions of distal acidic polymerized units along a single polymer chain (backbiting), or from acidic functions of separate polymer chains (crosslinking). Backbiting and crosslinking are generally undesirable and may interfere with modification and flow.

Preferably, at least 50 wt. %, or, more preferably, 90 wt. % or, even more preferably, 97 wt. % or more of the total methacrylic imide and anhydride groups on the backbone polymers of the present invention are cyclic and form from neighboring methacrylic acid polymerized units along a single polymer chain.

Crosslinking the imide functionality on the comb polymers of the present invention through imidization with multifunctional amines, such as bis-amino polyethers or multiple amine group-terminated dendritic polyethers molecules, for such purposes as molecular weight building is considered within the scope of this invention.

Preferably, the comb polymers of the present invention are linear and have ether, diether or polyether side chains coming off their imide nitrogens; thus, there are no imides or anhydrides that crosslink or backbite along the backbone polymer.

The comb polymers of the present invention may be further functionalized at remaining acid groups to form ester or amide side chains, including quaternary ammonium groups, other polyethers, and hydrophobic esters or amides, such as, for example, polyolefins, or fatty esters or amides.

A major advantage of the present invention is that the comb polymers can contain one or more quaternary ammonium group biocidal agents as salts on the acid functional groups on the backbone of the comb polymers. In contrast to known technology the biocide is dissolved in the water and more easily contaminates groundwater or the ambient surroundings. As the comb polymers are not attacked by bacteria and therefore do not promote or sustain bacteria growth, the need for biocidal activity is much reduced over known technology. The compositions of the present invention comprising quaternary ammonium carboxylates on the backbone polymer is of particular use in oil and gas production activities many of which, including fracking and several forms of enhanced oil recovery, require the water used therein to have increased viscosity.

Hydrophobic esters or amides can comprise any C₁ to C₅₀₀ alkyl aryl, aromatic or cycloaliphatic hydrocarbons and oligomeric olefins or polyolefins. For any polyolefin side chain, the Mw may be at least the entanglement molecular weight of an intended host polyolefin, and is, preferably, at least twice the entanglement molecular weight of an intended host polyolefin, such as polyethylene or polypropylene. Thus for use in polyethylene compositions, the molecular weight of one or more linear ester or amide side chain is, preferably, from 2400 to 50,000, or 5,000 or more Daltons and for use in polypropylene is, preferably, from 5600 to 100,000, or 10,000 or more Daltons.

The phosphorus acid group containing backbone polymers of the present invention have on average at least one phosphorus atom in the backbone polymer that is bound to a carbon atom, as a terminal or pendant group. Terminal groups may be a phosphinate or phosphonate, such as a monophosphinate, having a vinyl polymer backbone substituent. The at least one phosphorus atom in the backbone polymer can be bound to two carbon atoms, as a phosphite along the carbon chain, such as a diphosphinate having two vinyl polymer backbone substituents, e.g., a dialkyl phosphinate. The varied structures of such polymers is described in U.S. Pat. No. 5,294,686 to Fiarman et al.

In accordance with the methods of present invention, phosphorus acid group containing precursor polymers are formed by aqueous solution polymerization, are dried at temperatures high enough to form methacrylic anhydride and methacrylic acid group containing backbone polymers, which are then reacted with an etheramine, diether amine, polyetheramine, bis-amine ether group containing compound or tris- or multiple amine ether group containing compound in a fluid medium, such as a melt or non-aqueous medium, to form ether group containing amic acid side chains and/or crosslinks, and heating to form cyclic methacrylic imide groups from the amic acid and a neighboring cyclic methacrylic acid on the backbone polymer and form the six-membered cyclic methacrylic imide group containing comb polymers. The amic acid side chains can also be dehydrated by chemical agents like 3-picoline or a combination of chemical agents and heat to form a six-membered cyclic methacrylic imide group from the amic acid and a neighboring methacrylic acid on the polymer.

In accordance with the present invention, the phosphorus acid group containing precursor polymers are formed by conventional aqueous solution polymerization methods in the presence of the phosphorus acid compound from of 60 wt. % or more and up to 98 wt. % of methacrylic acid (MAA) and/or its salts, preferably, 71 wt. % or more, or, more preferably 86 wt. % or more, and the remainder of one or more phosphorus acid compounds and, if desired, a vinyl or acrylic comonomer, based on the total weight of monomers and reactants including the hypophosphite that are used to make the backbone polymer.

Suitable comonomers for use in making the precursor polymers of the present invention may be any vinyl or acrylic monomer which is thermally stable such that a homopolymer of the monomer having a weight average molecular weight of 50,000 would lose less than 5 wt. % of its weight corresponding to polymer degradation at 250° C. after 15 minutes by thermogravimetric analysis (TGA).

Suitable comonomers include, for example, methacrylamide, C₁ to C₆ alkyl (meth)acrylamides, C₁ to C₆ dialkyl (meth)acrylamides, styrene and alpha-methyl styrene, acrylic acid and C₁ to C₆ alkyl methacrylates, and are, preferably, methyl methacrylate, or ethyl acrylate.

As for comonomer proportions suitable for use as starting materials for use in making the precursor polymers of the present invention, adding too much of any comonomer which is not water soluble, such as styrene, will result in a monomer mixture may be difficult to solution polymerize or which exhibits sluggish reaction kinetics. If one uses too much of any comonomer, one cannot achieve a sufficiently high proportion of methacrylic anhydride groups on the backbone polymer of the present invention and may not achieve the corresponding thermal stability or advantageous reactivity conferred by such anhydride groups.

Suitable phosphorus acid group containing compounds for use in making phosphorus acid group containing precursor polymers of methacrylic anhydride include, for example, phosphorous+1 compounds, for example, hypophosphite compound or its salt, such as sodium hypophosphite; phosphorus+2 compounds, such as, a phosphonate compound, for example, phosphonic acids or their inorganic salts or ammonium, e.g., alkali(ne earth) metal salts; phosphorus+3 compounds, such as C₁ to C₄ dialkyl or trialkyl or phenyl phosphites or diphenyl phosphites; and orthophosphorous acid or salts thereof.

Preferably, the precursor polymers are chosen from hypophosphite or phosphite containing homopolymers of methacrylic acid, i.e., made from methacrylic acid and phospite or hypophosphite compound reactants only, and phosphite containing homopolymers of methacrylic anhydride, hypophosphite group containing copolymers of methacrylic acid made with less than 25 wt. %, or, more preferably, less than 10 wt. %, based on the total weight of monomers used to make the precursor polymer, of vinyl or acrylic monomers other than methacrylic acid or its salts.

Preferably, the precursor polymers are chosen from hypophosphite phosphite containing homopolymers of methacrylic anhydride, i.e., made from methacrylic acid and phosphite or hypophosphite compound reactants only.

Forming the backbone polymers of the present invention from the precursor polymers comprises drying the precursor polymers at a temperature of 175° C. or higher, and up to 250° C., preferably, 180° C. or higher, and, preferably, 220° C. or less, preferably, with drying while under shear.

Drying times are lower at higher temperatures and generally range from 10 seconds to 8 hours, preferably, 30 seconds to 2 hours, or, preferably, 1 hour or less, more preferably, 2 to 45 minutes. In the case where initial drying is followed by heating, such as spray drying and further heating, the further heating takes place at the above recited temperatures for a period of from 30 seconds or more, or, up to 90 minutes, preferably, 45 minutes or less, more preferably, 1 minute to 30 minutes.

Drying the precursor polymers to form methacrylic anhydride group containing backbone polymers comprises any of several known methods that will dehydrate such polymers and form methacrylic anhydride groups. Suitable methods may include, for example, extrusion, such as in a single-screw or twin-screw extruder; kneading, such as in a single shaft or twin-shaft kneader reactor, banbury mixer, or a Buss-Kneader Reactor or Single screw reciprocating extruder/mixer; evaporation, such as in a wiped film evaporator or falling film evaporator vessel; heated mixing, such as in a continuous stirred tank reactor (CSTR) or single and twin-rotor mixers, for example, PLOUGHSHARE™ Mixers (Littleford Day Inc., Florence, Ky.), double arm mixers, sigma blade mixer, or vertical high intensity mixer/compounders; and spray drying or fluid bed drying, coupled additional higher temperature drying, such as drum dryers or belt dryers. Drying to form the anhydride may also be achieved by exposing the precursor polymer to heat in an non-agitated fashion, such as on a flat plate heater, optionally under vacuum, or a heated conveyor equipped with a hood or other volatiles removal device.

Preferably, to make backbone polymers with cyclic methacrylic anhydrides and not by backbiting or intrachain crosslinking, drying is carried out with no or as little agitation or shear as possible in an oven, or any extruder, kneader or kneader reactor comprising a low shear extruder. Low shear extruders may comprise any having at least one zone that expands in a direction transverse to the rotational axis of the extruder screw(s) and in a direction away from any devolatilizer in the low shear zone, any having a barrel with flights for biasing the melt toward the end of the barrel, single screw extruders, co-rotating twin-screw extruders and counter-rotating twin screw extruders, as well as extruders having more than one of these features such as single screw extruders having at least one zone that expands in a direction transverse to the rotational axis of the extruder screw(s) and in a direction away from any devolatilizer in the low shear zone or single screw extruders having a barrel with flights for biasing the melt toward the end of the barrel.

Preferably, a devolatilizing extruder containing one or more devolatilizing zones is used to dry the precursor polymer of the present invention; and the fill level in the devolatilizing zone is less than 100% full and is operated in a manner such that there is less than or zero gauge pressure. This minimizes the risk of solid material leaving the screw channels and operates at a pressure such that any residual water volatilizes out of the extruder and results in advancing the equilibrium reaction to form additional anhydride functional groups along the polymer backbone.

The dried backbone polymers are then reacted at from 0 to 250° C. or, preferably, from 15 to 140° C. with an ether group containing amine compound to form amic acid groups. This will open methacrylic anhydride rings on the backbone polymer. Because the heat used in drying is so great, residual heat from drying may be relied upon to form the ether group containing amic acid, for example, by forming the amic acid in the same vessel or device use to dry the precursor polymer to form the backbone polymer, e.g., any melt mixing device. The heat of amic acid formation if above 160° C. may further cause ring closing to form an imide.

After ring opening and amic acid formation on any backbone polymer the backbone polymer should be heated to ring close and form the six-membered cyclic imide functionality at from 100 to 250° C., preferably, from 160 to 220° C. Such heating can take place for a period of from 1 min to 24 hours, or, preferably, from 5 min to 6 hours. The amic acid can also be dehydrated by chemical agents to form a six-membered cyclic methacrylic imide group from the amic acid and a neighboring methacrylic acid on the polymer with a chemical dehydrating agent such as a base catalyst like 3-picoline, which can be combined with acetic anhydride. Heat and chemical dehydration can be combined; and chemical dehydration may be done from 0 to 200° C., preferably from 15 to 100° C. over a period of 1 minute to 8 hrs., or preferably from 5 minutes to 2 hours.

The same extruder can be used to prepare (drying) the methacrylic anhydride backbone polymer and to prepare (form amic acid and ring close) the cyclic methacrylic imide polymer from it; or separate extruders can be used. Suitable extruders are, for example, those made by Welding Engineers, American Liestritz, or Werner-Pfliederer. Preferably, the extruder is a low shear extruder; more preferably, it is a devolatilizing extruder wherein the fill level in the devolatilizing zone is less than 100% full.

Staged reactive extrusion may be used and comprises placing the precursor polymer in an extruder and heating as needed to form the desired proportion of methacrylic anhydride groups, which occurs rapidly (in 1 to 5 minutes), followed by injecting the amine to rapidly form the amic acid and the imide. Still further, at a later stage, adding an alcohol or amine compound at the desired temperature will form an ester or amide on remaining acid functionality in the backbone polymer.

Any amount of from 7.5 to 100 wt. % of the anhydride in any backbone polymer is converted to a six-membered cyclic imide. Preferably, for each mole of methacrylic acid polymerized units in the backbone polymers, 50 to 70 wt. % of the methacrylic acid polymerized units in any backbone polymer are converted to a six-membered cyclic imide. More preferably, 60 to 68 wt. % of the methacrylic acid polymerized units in the backbone polymer are converted into the six-membered cyclic imide.

Preferably, to insure a more linear backbone polymer and provide comb polymers with methacrylic anhydrides and six-membered cyclic methacrylic imides, the backbone polymers of the present invention comprise only up to less than 70 wt. %, for example, 50 to 68 wt. %, in total of the methacrylic anhydrides plus the six-membered cyclic methacrylic imides, based on the total amount of methacrylic acid polymerized units in the backbone polymer, preferably at least 50 wt. % of which are six-membered cyclic methacrylic imides. Such polymers may comprise less than 2 wt. % of anhydrides formed via backbiting or crosslinking.

To form a six-membered cyclic methacrylic imide group containing backbone polymer, the methacrylic anhydride group containing backbone polymer may be reacted with an amine compound, such as a primary amine containing compound in the same or different extruder as in which the backbone polymer is formed by drying, or a separate extruder or a heated non-aqueous fluid medium, such as, for example a mixture of N,N-dimethylacetamide and toluene, 1-methyl-2-pyrrolidone and toluene, or 1-methyl-2-pyrrolidone and xylenes.

Reaction of methacrylic acid or anhydride in the comb or backbone polymers with any amine or alcohol compound to form, respectively, six-membered cyclic imides or anhydrides may be done in the solution phase or in melt phase; if done in solution phase, the reaction is preferably done stepwise by reacting with amine to form amic acid or with alcohol to form an ester at about room temperature, followed by ring closing to form, in the case of amines, the six-membered cyclic imide by heating to 100 to 200° C. or, in the case of alcohols, the anhydride, by heating to 160 to 250° C. A ring closing agent, such acetic anhydride with picoline may be used and ring closing temperatures lowered accordingly.

The comb polymers of the present invention may be also made by partially amidating phosphite and hypophosphite group containing polymethacrylic acid, e.g., spray dried polymethacrylic acid to form amide side chain groups or amic acid groups, and then heating the amidated product to temperatures sufficient to ring close (100 to 200° C.) the amic acid groups and yield, six-membered cyclic imide functionality on the backbone polymer.

Preferably, imidization of or all of imidation and amide formation of the methacrylic anhydride group containing backbone polymer takes place in an extruder having a devolatilization zone and any ether group containing amine compounds are preferably used in anhydrous form, but can contain a small amount of less than 10 wt. %, or, preferably, less than 5 wt. % of water.

Ether group containing N-substituent side chains or crosslinks can be formed either as part of a six-membered cyclic methacrylic imide or they can be formed as an amide on a methacrylic acid or its salt. The ether groups, in whatever form, are produced from an ether group containing amine compound, preferably, a primary amine, including an ether amine, diether amine, polyether amine, or a bis-amine ether compound, including any of bis-amine ether, bis-amine diether or bis-amine polyether or a or a multiple-amine ether compound having three or more amine groups and including any of an ether, a diether or a polyether. The bis-amino and multiple-amine ether compounds can crosslink backbone polymers, which are still defined as “linear” where the only crosslinks therein are from amine group containing ether compounds.

Suitable examples of such ether group containing amine compounds are polyetheramine, any monoamine or bis-amine terminated polyether or dendrimer (multiple amine terminated ether group containing compounds) comprising chains of CH₂—CH₂—O units, for example, from 1 to 500 such units, or, preferably, from 1 to 100 units, or, in hydraulic cements, preferably from 5 to 100 units. Examples of ether group containing amine compounds are mono-amine terminated polyethers (M-Jeffamine™ polymers, Huntsman International, LLC, Salt Lake City, Utah), bis- or tris-amine groups terminating two and three ends of the polyether chains (respectively, the D and T series Jeffamine™ products, Huntsman).

Suitable ether group containing amine compounds may also comprise, up to 50 wt. % or, up to 30 wt. % of the total ether units, randomly or in blocks, propylene oxide units [CH₂—CH(CH₃)—O].

Preferably, the ether group containing amine compound is a polyetheramine having at least 60 wt. % ethylene oxide groups (EO) as a percent of all ether groups, or, more preferably, at least 80 wt. % EO groups, and, most preferably, at least 90 wt. % EO groups.

By reaction of the backbone polymers of methacrylic anhydride in the presence of any bis-amine or multi-amine terminated ether compounds or polyethers, one can build higher molecular weight comb polymers through crosslinking, or one can build higher viscosity in a given aqueous compositions through chain entanglement.

As the comb polymers of the present invention have methacrylic acid or salt groups as well as six-membered cyclic methacrylic imides, other amine or alcohol compounds may be reacted onto the backbone polymer to form other functional groups in a comb polymer. Some or all of remaining methacrylic acid or salt groups can be esterified, converted to amides, converted to salt ionomer, such as with NaOH or metal hydroxides and oxides, or any combination of these. The salt may comprise any cation or combination of cations, such as sodium or iron (III). For example, the six-membered cyclic methacrylic imide group containing comb polymers may be further functionalized at remaining acid groups to form ester or amide side chains, including hydrophobic groups, like fatty esters or amides.

Preferably, to insure the presence of some methacrylic acid, salt or anhydride in the product comb polymers of the present invention, the amount of alcohol or amine compound, as molar equivalents (1 mole of monoalcohol or monoamine (e.g., hexylamine) means 1 molar equivalent of such alcohol or amine), used to form ether group containing N-substituents on six-membered cyclic methacrylic imides in the backbone polymers of methacrylic anhydride is, preferably, equal to or less than that required to react with all of the methacrylic acid polymerized units that are anhydrides in a given backbone polymer of methacrylic anhydride, for example, from 0.1:1 to less than 1:1 molar equivalents amine or alcohol to molar equivalents of methacrylic anhydride acid polymerized units, or, preferably, 0:95:1 or less or, preferably, 0.2:1 or more, or 0.5:1 or more.

An excess of the amine compound excess may be used to expedite amide and imide formation kinetics; after reaction, the excess can then be removed by stripping.

Esterification or amidation of the comb polymer or any methacrylic anhydride backbone polymer results from reacting it with a hydrophobic group containing alcohol or amine, such as a fatty alcohol or amine. The reactivity of the methacrylic anhydride or methacrylic acid in the phosphorus acid group containing backbone polymers or comb polymers of the present invention enables ready side chain formation in a heated melt or mixture of backbone polymer and hydrophobic group containing reactant alcohols or amines.

Amidation needs no added heat after drying because of the residual heat from drying; and amides may be formed from methacrylic anhydride or acid groups and the indicated amine in the apparatus used for drying or in a different apparatus while the comb polymers are still at a temperature of above 40, or, preferably, above 100° C. In fact, the residual heat from making the backbone polymers of the present invention is more than sufficient to drive the reaction to form amides and make comb polymers of six-membered cyclic methacrylic imides having hydrophobic side chains.

Where esterification or amidation in any backbone methacrylic anhydride group containing polymer opens anhydride rings in the backbone polymer, the polymers will contain free neighboring methacrylic acid groups and the polymers may be heated to from 100 to 250° C. or higher to ring close and form anhydride (from ester) or imide (from amide) functionality.

Preferably, the six-membered cyclic methacrylic imide group containing backbone polymers are formed first, and then the polymers can be modified by reacting any remaining carboxylic acid or salt group methacrylic polymerized units to esterify or amidate them, or by forming salts thereon.

For use as thickeners, any combination of mono-amines, multi-amines, providing, with appropriate selection of remaining acid functionalization, a water soluble polymer, are within the scope of this invention. Reactions with other alcohol or amine compounds may be carried out between them and any of the precursor methacrylic acid polymers, the methacrylic anhydride backbone polymers and the imide containing comb polymers. Any such reactions may be followed, if need be, by ring closing to form methacrylic imides or anhydrides.

Other suitable amine group containing compounds useful to build molecular weight through backbone polymer intermolecular bridging via amidation may be any poly (amine) material, e.g., polylysine, or combination of materials including ethylene diamine, 1,6-hexanediamine, 1,3,5-benzenetriamine, non-polyol materials such as amine terminated polydimethylsiloxanes (PDMS), such as XIAMETER™ OXO-040112 (Dow Corning, Midland, Mich.), amine terminated polyolefins, and amine terminated block copolymers etc.

Reactive amine compounds, including the ether group containing amine compounds for forming side chains on the comb polymers of the present invention comprise one or more primary amines and can be terminated with an alcohol, secondary amine or other species reactive to the backbone polymer.

Amine compounds may also comprise reactive groups that are unreactive towards the anhydride groups and methacrylic acid groups on the backbone polymer and which, therefore, would be available for further reaction with a third component. Such reactive groups may be, for example, anhydride, vinyl, or carboxylic acid group containing compounds.

Examples of reactive side chain materials (reacting to a third component other than the backbone polymer or itself) are biocidal quaternary ammonium compounds which can be used to form a salt with carboxylic groups remaining after forming the six-membered cyclic methacrylic imide groups on the backbone polymer to provide a biocidal viscosifier.

Examples of hydrophobic side chains for the comb polymers of the present invention may include one or a distribution of chain lengths, and may be chosen from one or more or a distribution of polyolefins, C₁ to C₅₀₀ hydrocarbons, cycloaliphatic hydrocarbons, or aryl hydrocarbons. Suitable materials for making such hydrophobic side chains may be fatty alcohols or fatty amines having a C₁ to C₅₀₀, or, preferably, a C₆ to C₂₅₀ alkyl group; olefinic alcohols or amines, such as amine terminated polyolefins, and amine terminated block copolymers or oligomeric olefins terminated with an alcohol or amine; anilines or cyclohexylamines. Further, alcohol or amine terminated C₁ to C₅₀₀ alkyl or, preferably, C₆ to C₂₅₀ alkyl compounds can contain a cycloaliphatic or aryl groups along a hydrocarbon chain or as a pendant group on a hydrocarbon chain, for example, 3,3-diphenylpropylamine or diphenylpropanol.

Examples of polyolefin side chain forming materials may include amine terminated polyolefins where the polyolefin is, for example, polyethylene, an ethylene/alpha-olefin copolymer wherein the alpha-olefin is butane or a higher alkyl group, or a block copolymer or a pseudo-block copolymer as described in any of U.S. Pat. Nos. 7,608,668, 7,947,793, or 8,124,709, polypropylene, ethylene/propylene copolymers or block copolymers or pseudo block copolymers, as described in any of U.S. Pat. Nos. 8,106,139, or 8,822,599.

The comb polymer compositions of the present invention may be modified to comprise quaternary ammonium groups on at least one of the carboxylic acid groups of the backbone polymer. Preferably, the quaternary ammonium group is chosen from dimethyl di(dodecyl) ammonium ([CH₃)₂(C₁₂H₂₅)₂N]⁺).

According to the present invention, adding quaternary ammonium group functionality on a free carboxylic acid such as methacrylic acid or its salts comprise neutralizing the acid with a fixed base, such as a metal hydroxide, e.g., NaOH, then ion exchanging the metal salt cation with a suitable quaternary ammonium compound.

A quaternary ammonium salt of the methacrylic acid can be formed directly with a quaternary ammonium compound.

Suitable quaternary ammonium compounds may be any known compounds, such as tetramethylammonium hydroxide, tetramethyl ammonium chloride, nonyl trimethyl ammonium bromide, decyl trimethyl ammonium bromide, dodecyl trimethyl ammonium bromide, tetradecyl trimethyl ammonium bromide, hexadecyl trimethyl ammonium bromide, octadecyl trimethyl ammonium bromide, didecyl dimethyl ammonium chloride, didecyl dimethyl ammonium bromide, didodecyl dimethyl ammonium bromide, dioctadecyl dimethyl ammonium bromide, benzyl dimethyl octadecyl ammonium bromide, tetradecyl, octadecyl benzyl dimethyl ammonium chlorides, dodecyl tetradecyl octadecyl benzyl dimethyl ammonium chlorides, cationic bisguanides, and mixtures thereof. All compounds mentioned in this paragraph are available from Aldrich Chemicals, St. Louis, Mo. Where the methacrylic acid on the backbone polymer is esterified, the ester may be formed with alkyl alcohol wherein the alkyl chain has a linear chain length of at least 15 carbons or, preferably, at least 30 carbons, and, most preferably, at least 50 carbons.

The alkyl alcohol may contain a distribution of chain lengths such as those present in UNILIN™ alcohols supplied by Baker Hughes (Houston, Tex.) may be used, preferably, an approximately C₅₀ alcohol (Unilin™ 700 alcohol) which has an average of 50 carbons in the alcohols.

The comb polymers of the present invention can readily be manipulated to tune their hydrophobicity and hydrophilicity for specific attributes.

Preferably, the comb polymers of the present invention comprise one or more ether, diether or polyether imide side chains and either an alkyl ester side chain from methacrylic acid esterification or a quaternary ammonium compound.

The compositions of the present invention may be used for several uses including but not limited to: viscosification (thickening) of water containing or aqueous compositions, viscosification combined with biocidal activity, dispersants and additives to polymers, either compounded in the polymer or applied to the surface of the polymer article.

Compositions comprising quaternary amine salts of the carboxylic acid groups on the backbone polymer is of particular use in oil and gas production activities many of which, including fracking and several forms of enhanced oil recovery, require control of bacteria, mold and other organisms.

### EXAMPLES

The following examples illustrate the present invention. Unless otherwise indicated, all parts and percentages are by weight and all temperatures are in ° C.

Test Methods: In the Examples that follow, the following test methods were used:

Titration: The number of methacrylic anhydride groups present on a backbone polymer and the number of carboxylic acid groups present on a given precursor polymer or backbone polymer as a percentage of total methacrylic acid polymerized units in the polymer was determined by titration. First, the total free carboxylic acid content was measured by hydrolysis of the anhydride. A 0.1-0.2 g of each material was measured and put in a 20 ml glass vial. To this, 10 ml of deionized (DI) water was added and the closed vial was heated in 60° C. oven for 12 h. After 12 h, the vial was titrated against 0.5 N KOH (aq.) to determine acid number of the thus hydrolyzed polymethacrylic anhydride polymer (the total free carboxylic groups in the polymer). Next, the anhydride content was determined by reacting the same pMAAn material in its unhydrolyzed state with methoxy propyl amine (MOPA). MOPA opens the anhydride and reacts with one side, the other side is converted back to a carboxylic acid. For each polymer tested, 0.1-0.2 g of each pMAAn material along with 10 ml of tetrahydrofuran (THF) and 0.2-0.3 g of MOPA was added to a 20 ml glass vial equipped a with magnetic stirrer bar. The vial was closed and the mixture was stirred at room temperature overnight (about 18-20 h). Following this 10 ml of DI water was added and mixture was titrated against 0.5 N HCL (aq.) to determine the anhydride content. Titration was used to determine the overall disappearance of carboxylic acid in the polymer which indicates the conversion of carboxylic acid groups to anhydride. The calculated percentage of COOH (acid groups) converted into anhydride=(mols of anhydride in 1 g of polymer sampled)/(Total mols of —COOH in 1 g of hydrolyzed polymer sampled)*100. Instrument: Titralab TIM865 Titration Manager (Radiometer Analytical SAS, France); Reagents: 0.5 N KOH. 0.5 N HCl, Tetrahydrofuran (Sigma Aldrich. St Louis, Mo.).

Methacrylic Imide Content Verified by FTIR: For each polymethacrylic imide group containing polymer, the conversion of methacrylic anhydride groups in a corresponding methacrylic anhydride polymer into methacrylic imide groups was confirmed qualitatively by FTIR of the methacrylic imide group containing polymer itself.

FTIR: Methods A) or B) as described, above.

### Synthesis Example 1

### Methacrylic Anhydride Group Containing Backbone Polymer With 66.7 Wt. % of Methacrylic Anhydride Groups

Spray dried hypophosphite group containing polymethacrylic acid having an Mw of ˜5K was heated under vacuum (pressure 17 mm Hg). for 4 hrs. at 200° C. The spray dried material remains melted at about 185° C. and the melt is not agitated during the dehydration process. After cooling under vacuum the now solid mass is crushed and stored in anhydrous conditions. The resulting backbone polymer material has 66.7% of the polymerized methacrylic acid content been converted to anhydride, as determined by titration. The material contains equal moles of anhydride functionality and carboxylic functionality.

### Synthesis Example 2

### Methacrylic Anhydride Group Containing Backbone Polymer With 92.3 Wt. % of Methacrylic Anhydride Groups

The polymer was manufactured as described in U.S. Pat. No. 8,859,686, except that this material was subject to a second heat stage. A Haake PolyLab System™ (Model P300) mixer (Thermo-Fisher Scientific, Waltham, Ma.) comprising control of temperature and rotor speed, was used, made up of a Haake Rheomix™ 600P mixer fitted with a R600 bowl (120 mL chamber volume, excluding rotors; about 65 mL volume with rotors installed), in turn fitted with co-rotating (Rheomix™ 3000E) roller rotors (Thermo-Fisher) geared at a 3:2 ratio, a Haake Rheocord™ used to measure the torque established between the rotors, and Polylab™ Monitor V 4.18 control software provided as part of the system and used to control rotor speed, temperature and record torque, equipment and melt temperature. A mixing bowl was made of 301 stainless steel—DIN 1.4301 (SS-301, Deutsches Institut für Normung e.V., Berlin, DE, 2014); the rotors were made of 316 stainless steel—DIN 1.4408 (SS-316, 2014)).

A 35 g sample of powdered, spray dried hypophosphite group containing polymethacrylic acid (pMAA) having an Mw of ˜5K was introduced to the mixing bowl which was stabilized at 185° C. via a removable funnel. The screw speed was set to 50 PRM. The bowl temperature set points (i.e., all three) were set to 190° C. After the polymer had melted, shown by a spike in torque, a second 15 g batch of the pMAA was added; this was accompanied by a second torque spike. A nitrogen purge was implemented after the second batch of pMAA had melted to prevent the light powder from being blown out of the chamber; mixing was then continued at 190° C. for 10 minutes. Thereafter, the temperature was raised to 225° C. and run for 30 minutes. Rotor speed was reduced to 3 RPM and the immediately thereafter Haake bowl was removed while hot and the polymer inside removed and cooled before packaging. This step was done in ambient conditions and thus the hot material was exposed to moisture in the atmosphere. The material was removed from the bowl while still in a softened state. After cooling, the material removed from the Haake bowl was, in all cases, very brittle, with a fibrous texture. A second batch was made as above and the batches combined The combined methacrylic anhydride backbone polymer (pMAAn) batches were remixed in clean a Haake bowl as follows:

The Haake bowl was stabilized at 185° C., 35 g of powdered pMAAn (combined batches were ground together with mortar and pestal) was introduced to the bowl via the removable funnel. The screw speed was set to 50 PRM. The bowl temperature set points (i.e., all three) were set to 190° C. After the pMAAn backbone polymer had melted, shown by a spike in torque, the second 15 g batch of pMAAn was added; this was accompanied by a second torque spike. A nitrogen purge was implemented, and—mixing continued at 190° C. for 10 minutes. Then, the temperature was raised to 225° C. and run for 30 minutes; the rotor speed was reduced to 3 RPM and the immediately thereafter Haake bowl removed while hot and the polymer inside removed and cooled before packaging.

Titration of the resulting polymethylacrylic anhydride backbone polymer was found to contain 92.28 wt. % anhydride (i.e., of the original carboxylic acid, 7.72% remained as acid, the remainder being in anhydride form), based on the total weight of methacrylic acid polymerized units in the polymer.

### Example 1

### Reaction of Poly(methacrylic acid-co-methacrylic anhydride) of Synthesis Example 2 With Polyetheramine (˜19 EO Groups)

Into a 3-neck, 250 mL round bottom flask with Dean-Stark trap and condenser under a gentle nitrogen stream along with a magnetic stir bar was loaded anhydrous 1-methyl-2-pyrrolidone (100 ml) and the poly(methacrylic-co-methacrylic anhydride) of Synthesis Example 2 (1.535 grams). The apparatus was insulated, placed in a variable transformer regulated heating mantle sitting on a magnetic stir plate. Flask was gently warmed to dissolve polymer and is then cooled to room temperature. A Jeffamine™ M1000 polyetheramine (Huntsman Int'l LLC, 7.40 grams) was injected into the flask and stirred at room temperature under nitrogen for 72 hours. Toluene was loaded into the apparatus with 20 ml added to the Dean Stark trap and 25 ml added to the flask. Toluene was refluxed for 2.5 hours and then distilled and drained from the Dean-Stark trap. The resulting mixture was added to diethyl ether with product settling. Diethyl ether was decanted and product was reslurried in fresh diethyl ether with ether layer decanted four times more. Product was dried in a 70° C. vacuum oven. Dried product was mixed with KBr to prepare a pellet for FTIR per method B, disclosed above.

### Example 2

### Reaction of Poly(Methacrylic Acid-Co-Methacrylic Anhydride) of Synthesis Example 1 With Polyetheramine (˜19 EO Groups)

Into a 3-neck, 500 mL roundbottom flask with Dean-Stark trap and condenser under a gentle nitrogen stream along with a magnetic stir bar was loaded 1-methyl-2-pyrrolidione (278.7 grams) and toluene. Apparatus was insulated, placed in variable transformer regulated heating mantle sitting on a magnetic stir plate. Toluene was distilled into the Dean-Stark trap and subsequently drained. Flask was cooled under nitrogen to room temperature and the poly(methacrylic-co-methacrylic anhydride) (10.69 grams) was added to flask with flask contents warmed to about 180° C. to dissolve the polymer. Flask's contents are cooled to about room temperature with warm JEFFAMINE™ M1000 (40.04 grams) polyetheramine (Huntsman) injected into the flask and stirred overnight at room temperature. Toluene (45 mL) was added to the flask and flask was warmed to reflux for 5 hours into the Dean-Stark trap, then toluene was drained off. Reaction mixture was cooled to room temperature. Remaining solvent was stripped from product in warm vacuum oven with product being a clear, light yellow, viscous liquid while warm.

### Example 3

### Reaction of Poly(Methacrylic Acid-Co-Methacrylic Anhydride) of Synthesis Example 1 With Polyetheramine (˜19 EO Groups) (Alternative Method)

Into a 3-neck, 100 mL roundbottom flask with magnetic stir bar and fitted with inlet adaptor, stopper, and Dean-Stark trap with condenser and outlet adaptor was loaded N,N-dimethylacetamide (50 mL) and toluene (15 mL) with apparatus under a slow nitrogen sweep. Toluene was distilled and drained from the Dean-Stark trap. Poly(methacrylic acid-co-methacrylic anhydride, 2.10 grams, was added to the flask and warmed to dissolve in the N,N-dimethylacetamide to a temp of about 120° C. and then cooled. To the ambient temperature solution was added the Jeffamine™ M1000 (6.90 grams) polyetheramine was added. Mixture was stirred overnight at ambient temperature. Toluene was placed in the flask (10 mL) as well as filling the Dean-Stark trap. Toluene was refluxed for about 9 hours with toluene and water drained from the trap. Product solution has solvent removed in a 100° C. vacuum oven. Inherent viscosity of product=0.111 dL/g (30.0° C., 0.50 g/dL, N-methyl-2-pyrrolidinone).

### Example 4

### Reaction of Poly(Methacrylic Acid-Co-Methacrylic Anhydride) of Synthesis Example 1 With Polyetheramine (˜19 EO Groups) and a bis-amine polyether (˜4 PO groups)

Into a 3-neck, 100 mL roundbottom flask with magnetic stir bar and fitted with inlet adaptor, stopper, and Dean-Stark trap with condenser and outlet adaptor was loaded N,N-dimethylacetamide (50 mL) and toluene (15 mL) with apparatus under slow nitrogen sweep. Toluene was distilled and drained from the Dean-Stark trap. Poly(methacrylic acid-co-methacrylic anhydride)(50/50 mole/mole, 2.10 grams) was added to the flask and warmed to dissolve in the N,N-dimethylacetamide to a temp of about 120° C. and then cooled. To the ambient temperature solution was added Jeffamine™ D230 (0.196 grams) bis-amino polyether (Huntsman) and 6.5 hours later Jeffamine™ M1000 (6.94 grams) polyetheramine was added to the solution. Mixture was stirred overnight at ambient temperature. Toluene was placed in the flask (10 mL) as well as filling the Dean-Stark trap. Toluene was refluxed for about 9 hours with toluene and water drained from the trap. Product solution has solvent removed in a 100° C. vacuum oven. Inherent viscosity of product=0.124 dL/g (30.0° C., 0.50 g/dL, N-methyl-2-pyrrolidinone).

Example 4 demonstrates the increasing of molecular weight by use of small amount of a bis-amine polyether (Jeffamine™ D230 polymer) comprising a propylene oxide polyether. The increase in molecular weight was demonstrated by measuring inherent viscosity. Example 3 was a direct comparison as the method of reacting was the same except no D230 was used. The inherent viscosity increased from 0.111 dL/g (example 2) to 0.124 dL/g (example 3) indicating that an increase in molecular weight occurred which amounted to more than a 10% increase.

All FTIR spectra for all examples are shown in the Table, below with all examples done by method B with Comparative Example 1, done as KBr pellet sample, and Examples 3 and 4, done as polytetrafluoroethylene (PTFE) card sample.

TABLE
FTIR Data from Comb Polymers

| Example #1 | | | Example #3 | | | Example #4 | | |
|---|---|---|---|---|---|---|---|---|
| Band | Strength | Assignment | Band | Strength | Assignment | Band | Strength | Assignment |
| | | | 1801 | W | Cyclic | 1801 | W | Cyclic |
| | | | | | anhydride | | | anhydride |
| | | | | | C═O | | | C═O |
| | | | 1759 | S | Cyclic | 1759 | S | Cyclic |
| | | | | | anhydride | | | anhydride |
| | | | | | C═O | | | C═O |
| 1718 | M | Imide C═O | 1723 | S | Imide C═O | 1720 | S | Imide C═O |
| 1670 | S | Imide C═O | 1671 | VS | Imide C═O | 1672 | VS | Imide C═O |

In Table 1, above, VS = very strong, S = Strong, M = Medium and W = weak, indicating to a degree the amount of each functional group shown. As the Table shows, all inventive comb polymers comprise at least a cyclic methacrylic imide group. In Examples 3 and 4, the stronger imide signals suggest a preferred higher imide yield than in Example 1.

### Example 5

### Reaction of the Backbone Polymer of Synthesis Example 1 With ˜10% Polyetheramine (˜19 EO Groups)

Into a 3-neck, 100 ml roundbottom flask with magnetic stir bar and fitted with inlet adaptor, stopper, and Dean-Stark trap with condenser and outlet adaptor was loaded N,N-dimethylacetamide (50 ml) and toluene (15 ml) with apparatus under slow nitrogen sweep. Toluene was distilled and drained from the Dean-Stark trap. The poly(methacrylic acid-co-methacrylic anhydride)(50/50 mole/mole, 2.10 grams) of Synthesis Example 1 was added to the flask and warmed to dissolve in the N,N-dimethylacetamide at about 120° C. To the ambient temperature solution was added Jeffamine™ M1000 polyetheramine (Huntsman Int'l. LLC, 0.87 grams) was added to the solution. Mixture was stirred overnight at ambient temperature. Toluene was placed in the flask (10 mL) as well as filling the Dean-Stark trap. The mixture was refluxed for about 9 hours with toluene (at ˜110° C.) and water drained from the trap. Product solution has solvent removed in a 100° C. vacuum oven leaving a glassy solid with recovered yield of 2.75 grams. Solution of final product was cast on a PTFE card for FTIR collection by method B.

The FTIR showed strong anhydride bands, which are stronger than the imide bands; and, also shows a strong carboxylic acid peak. Because less polyetheramine or amine reactant was used in example 5 than in Example 4, the imides in the Example 5 comb polymer were not as pronounced as in the Example 4 comb polymer. See Table 2, below.

TABLE 2
FTIR Results

| Example | Band (cm⁻¹) | Strength | Assignment |
|---|---|---|---|
| 1 | 1718 | M | Imide C═O |
| | 1670 | S | Imide C═O |
| 3 | 1801 | W | Cyclic anhydride |
| | | | C═O |
| | 1760 | S | Cyclic anhydride |
| | | | C═O |
| | 1723 | S | Imide C═O |
| | 1671 | VS | Imide C═O |
| 4 | 1801 | W | Cyclic anhydride |
| | | | C═O |
| | 1759 | S | Cyclic anhydride |
| | | | C═O |
| | 1720 | S | Imide C═O |
| | 1672 | VS | Imide C═O |
| 5 | 1801 | S | Cyclic anhydride |
| | | | C═O |
| | 1759 | VS | Cyclic anhydride |
| | | | C═O |
| | 1730 | M | Imide C═O |
| | 1701 | W-Shldr | Carboxylic acid |
| | | | C═O |
| | 1672 | W-Shldr | Imide C═O |

As shown in Table 2, above, the presence of strong imide peaks at about 1670 cm⁻¹ and also at above 1720 cm⁻¹ indicates the presence of six-membered cyclic methacrylic imide group containing polymers in inventive Examples 3, 4 and 5. The FTIR analysis of the polymer of Example 1 did not result in as strong a six-membered cyclic methacrylic acid imide signal; however, the analysis does confirm the presence of such groups.

We claim:

1. A comb polymer composition comprising a phosphorus acid group containing, backbone polymer of six-membered cyclic methacrylic imide having one or more side chain ether group containing N-substituent on a six-membered cyclic methacrylic imide chosen from an ether group, a polyether group, an etheramine group, a polyetheramine group, an ether group crosslinking the backbone polymer chains, and a polyether group crosslinking the backbone polymer chains, and, further, having at least one group chosen from a methacrylic acid group in polymerized form, its quaternary ammonium carboxylate its metal carboxylate, an ester side chain group, and anamide side chain group, wherein the side chain group is chosen from a hydrophobic ester or amide side chain, a polyether ester side chain, a polyether amide side chain, group, and combinations thereof, wherein the backbone polymer comprises from 60 to 100 wt. %, based on the total weight of monomers used to make the backbone polymer, of methacrylic acid polymerized units, regardless of their form.

2. The comb polymer compositions as claimed in claim 1, wherein the backbone polymer comprises a hypophosphite group containing backbone polymer.

3. The comb polymer compositions as claimed in claim 1, wherein the backbone polymer comprises from 90 to 100 wt. %, based on the total weight of monomers used to make the backbone polymer, of methacrylic acid polymerized units, regardless of their form.

4. The comb polymer compositions as claimed in claim 1, wherein from 7.5 to 95 wt. % of the methacrylic acid polymerized units are in the form of methacrylic anhydride groups or six-membered cyclic methacrylic imide groups which are formed from the methacrylic anhydride groups, as determined by titration of the backbone polymers containing methacrylic anhydride groups prior to forming the six-membered cyclic methacrylic imide groups to determine the total number methacrylic anhydride groups therein.

5. The comb polymer compositions as claimed in claim 4, wherein from 60 to 70 wt. %, of the methacrylic acid polymerized units are in the form of six-membered cyclic methacrylic imide groups or methacrylic anhydride groups.

6. The comb polymer compositions as claimed in claim 1, wherein the phosphorus acid group containing backbone polymers of six-membered cyclic methacrylic imide of the present invention, excluding the weight of any side chain groups or salt groups in the backbone polymers, have a weight average molecular weight (Mw) of from 1,000 to 25,000.

7. The comb polymer compositions as claimed in claim 1, wherein the phosphorus acid group containing backbone polymers of six-membered cyclic methacrylic imide further containing one or more methacrylic anhydride group or six-membered cyclic methacrylic anhydride group.

8. The comb polymer compositions as claimed in claim 1, wherein the phosphorus acid group containing backbone polymers of six-membered cyclic methacrylic imide of the present invention have one or more hypophosphite group and comprise from 1 to 20 wt. % of the hypophosphite compound or its salts in polymerized form, based on the total weight of reactants used to make the backbone polymer.

9. The comb polymer compositions as claimed in claim 1, wherein the ether group containing N-substituent is chosen from an ethoxy group, a propoxy group, a diethylene glycol, a dipropylene glycol, a polyether of ethylene oxide repeat units, preferably, a polyether of at least 90 wt. % of ethylene oxide repeat units, a polyether of propylene oxide repeat units, a polyether having ethylene oxide and propylene oxide units, and mixtures and combinations thereof.

10. The comb polymer compositions as claimed in claim 1, wherein the comb polymer has an Mw of from 1200 to 1,500,000 as determined as that of the backbone polymer in fully hydrolyzed form prior to the formation of any six-membered cyclic methacrylic imide groups thereon by GPC against a polyacrylic acid standard plus the total amount of any N-substituent groups, salts, quaternary ammonium groups, ester side chain groups, or amide side chain groups reacted with or contained in the backbone polymer as determined by N-substituent group yield, ester side chain yield, and amide side chain yield from any alcohol or amine compound as determined by NMR

11. A method for making comb polymers which are phosphorus acid group containing backbone polymers of six-membered cyclic methacrylic imide having one or more ether group containing N-substituents chosen from an ether group, a polyether group, an etheramine group, a polyetheramine group, an ether group crosslinking the backbone polymer chains, and a polyether group crosslinking the backbone polymer chains comprising:
aqueous solution polymerizing a monomer mixture of methacrylic acid and/or its salt with one or more phosphorus acid compound to form a precursor polymer having methacrylic acid polymerized units;
drying the precursor polymer in a melt at from 175 to 250° C., to form a methacrylic anhydride group containing backbone polymer having from 7.5 to 70 wt. % of the methacrylic acid polymerized units in the form of methacrylic anhydride, as determined by titration of the backbone polymer;
reacting in a fluid medium, at from 0 to 220° C. the methacrylic anhydride group containing backbone polymer with one or more ether group containing amine compound in a molar amount of amine not to exceed the moles of methacrylic anhydride in the methacrylic anhydride group containing backbone polymer, as determined by titration, to form at least one ether group containing amic acid group, and then reacting in a fluid medium the ether group containing amic acid group with a neighboring methacrylic acid group on the backbone polymer at from 100 to 240° C. to form ether group containing N-substituents and six-membered cyclic methacrylic imide groups on the backbone polymer.
